(19) United States
(12) Patent Application Publication
(10) Pub. No.: US 2004/0069764 A1
(43) Pub. Date: Apr. 15, 2004

(54) Heat cooking apparatus and self-cleaning functional material and manufacturing method thereof

(75) Inventors: Shuji Imai, Souraku-gun (JP); Masato Matsuda, Shiki-gun (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd

(21) Appl. No.: 10/624,169

(22) Filed: Jul. 21, 2003

(30) Foreign Application Priority Data
Jul. 23, 2002 (JP) P. 2002-214506
Jul. 23, 2002 (JP) P. 2002-214507

(51) Int. Cl. F27B 5/14

(52) U.S. Cl. 219/390

(57) ABSTRACT

A convection heater 23 is disposed along a back surface of a rear face plate 18 which is comprised of a stainless steel plate that forms a heating chamber 14. On a back side of the rear face plate 18, disposed is a circulation fan 22 by which, air in the heating chamber 14 is sucked from air intake use through-holes into the back side, and after it is heated by the convection heater 23, it is returned from air blowing use through-holes to the heating chamber 14. On a surface of an inner side of the heating chamber 14 of the rear face plate 18, a self-cleaning layer is formed by dissolving a self-cleaning material which oxide-decomposes and removes accreted dirt at high temperature into a porcelain enamel glaze and by applying and bake-sticking.

### BACKGROUND OF THE INVENTION

This invention relates to a heat cooking apparatus such as an oven/stove and so on, and in particular, relates to a heat cooking apparatus which excels at an aspect of a hygiene and an aspect of an environment. Also, this invention relates to a self-cleaning functional material which has a stainless-steel as a substrate and performs a self-cleaning function at high temperature and a manufacturing method thereof.

In a heat cooking apparatus, inner wall surfaces of the heat cooking apparatus becomes dirty due to liquid etc. which was spattered from food and seasoning by cooking, the liquid etc. accreted to the wall surfaces by high temperature heating is changed to varnish, and therefore, it has been strongly desired to remove this dirt and to always keep a heating chamber in a clean state.

On that account, in order to remove the accreted dirt, it has been conducted that a finishing agent containing a self-cleaning material (hereinafter referred to as SC material) is disposed in the heating chamber, which SC material is comprised of an oxidation catalyst having a self-cleaning effect. Since this SC material, as shown by the following formula, oxide-decomposes an organic matter at high temperature by the oxidation catalyst which is comprised of iron, manganese, copper and so on, it is possible to have a dramatic effect on dirt decomposition (removal) in a cooking apparatus.

CₓH_{y}O_{z}+nO₂→xCO₂+yH₂O

Here, as one example of a conventional heat cooking apparatus, FIG. 15 shows a structure of a periphery of a heating chamber 1 of an oven/stove. A rear face plate 2 of a rear face side of the heating chamber is comprised of a stainless steel plate in which a number of punched holes are formed, and to a front face side of this rear face plate 2, a front face plate having the SC material is attached. The front face plate 3 is formed in such a manner that a ground coat layer 5 of aluminum oxide (Al₂O₃) is formed on both surfaces of a porcelain enameling use steel plate 4, and a self-cleaning layer (hereinafter referred to as SC layer) 6 comprising the SC material is formed on a surface of an inner side of the heating chamber which is an opposite side of the rear face plate 2 side. Air in the heating chamber 1 is heated by a convection heater, and circulated in the heating chamber 1 by a circulation fan 8, and it is designed that air which was sucked through the front face plate 3 and the rear face plate 2 is returned again to the heating chamber 1.

In addition, it is desired that the SC layer 6 is disposed on the rear face plate 2, but it is considered that to directly apply the SC material to the rear face plate 2 which is comprised of a stainless steel plate has many technical problems due to a difference of thermal expansion rates and so on, and is extremely difficult by use of a normal technique. On that account, as shown in FIG. 8, on both surfaces of a porcelain enameling use steel 1, a ground layer 2 of aluminum oxide (Al₂O₃) and so on is formed, and further, on an outer side thereof, a self-cleaning layer (SC layer) 3 which is comprised of the SC material is formed, and thereby, a self-cleaning functional material was manufactured.

However, the SC material has a high thermal dependency to realization of a self-cleaning function, and its effect becomes low below predetermined temperature. Therefore, in the above-described heat cooking apparatus, since the front face plate 3 having the SC material is disposed apart from the convection heater 7, even in such a state that the convection heater 7 is turned ON, temperature of the SC material does not go up to temperature where the self-cleaning effect is performed, and the self-cleaning effect that the SC material inherently has can not be sufficiently performed. Then, when the front face plate 3 comes close to the convection heater 7, it goes to such a result that there occur defects such as crazing, cracks and so on through long repetitive uses. This is because, in case of a typical porcelain enamel glaze having boro silicate glass as a major component, application limit temperature of a porcelain enamel is about 400° C., and there occurs temperature up above this application limit temperature.

Also, by concentration of electric fields at the time of high-frequency heating, there occurs such a fear that a spark is generated between the front face plate 3 and the rear face plate 2.

Furthermore, in order to carry out enameling on the porcelain enameling use steel plate 4, there is a necessity to carry out substrate processing for forming the ground coat layer 5 on the porcelain enameling use steel plate 4, and in order to apply the SC material finally, complicated processing of at least two coats, and two bakes are to be carried out, which became an obstacle against improvement of productivity, cut-down of lead time, realization of low cost and so on.

And, as to application of enameling to the porcelain enameling use steel plate 4, in order to prevent deformation at the time of sintering the porcelain enamel and at the time of heating an oven, there is a necessity to thicken thickness of the porcelain enameling use steel plate 4 itself, and on that account, weight of a product becomes large, and thermal capacity thereof becomes large, and necessary heater capacity becomes large.

Also, in the above-described enameling processing and in other processing, for example, ceramics coating, since there is a necessity to have thermal insulation resin melted in, there is a necessity to use organic solvent, and there were problems in an aspect of safety, an aspect of hygiene, and an aspect of environment, as well as an aspect of cost.

### SUMMARY OF THE INVENTION

This invention is made in view of the above-described situations, and aims to provide a heat cooking apparatus which does not have defects such as crazing, cracks and so on, and which also does not invite larger weight and increase of cost, and can have the self-cleaning effect performed sufficiently, and excels also at an aspect of safety, an aspect of hygiene, and an aspect of environment. Also, the invention provides a self-cleaning functional material which can have a self-cleaning effect performed sufficiently, without inviting increase of cost, and which excels also at an aspect of safety, an aspect of hygiene, and an aspect of environment.

In order to accomplish the above-described aim, a heat cooking apparatus includes a heating chamber enclosed by plate members in which an object to be heated that is housed in the heating chamber is heated and cooked by a heater which is disposed along a part of the plate member forming the heating chamber, and in that, out of the plate members which form the heating chamber, at least the plate member which is directly heated by the heater is comprised of a stainless steel plate, and on a surface of an inner side of the heating chamber of this stainless steel plate, a self-cleaning layer is formed by coating a self-cleaning material, which is comprised of an oxidation catalyst which decomposes accreted dirt, by use of a porcelain enamel glaze as an accretion material.

Further, in the heat cooking apparatus, the porcelain enamel glaze may be one in which one type or more powder out of powders for enameling of aluminum, iron, nickel, copper, chromium, silver, bronze, and titanium is added to frit.

Further, in the heat cooking apparatus, the self-cleaning material may be comprised of one type or more oxidation catalyst out of iron oxide, manganese oxide, and copper oxide.

As above, according to the heat cooking apparatus as described above, since the self-cleaning layer was formed by accreting a self-cleaning material, which is not accreted to the stainless steel plate that is used as plate members forming the heating chamber, thereto by use of the porcelain enamel glaze as the accretion material, in particular, on the plate in the vicinity of the heater, it is heated up to high temperature by the heater, and it is possible to have the self-cleaning effect performed sufficiently in the self-cleaning layer, and it is possible to remove accreted dirt by surely decomposing it in the self-cleaning layer.

In short, since there occurs defects such as crazing, cracks and so on in a porcelain enamel layer for accreting the self-cleaning material, as compared to a conventional front face plate which has no other choice to be disposed away from the heater in some degree, it is possible to have it performed an extremely excellent self-cleaning effect.

Also, it is eliminated to use a thick porcelain enameling use steel plate to which the self-cleaning material is to be accreted by complicated processes, and it is possible to realize drastic improvement of productivity, weight saving and low cost, and also, it is possible to reduce necessary heater capacity and to realize reduction of electric power consumption.

Further, in the heat cooking apparatus, the self-cleaning layer may be formed by having the self-cleaning powder material, which is formed by having the self-cleaning material dissolved in the porcelain enamel glaze and powdered, mixed with water and by applying to the stainless steel plate and by bake-sticking.

In short, since the self-cleaning layer is formed by mixing with water and by applying and by bake-sticking, as compared to ceramics coating and so on using organic solvent, it is possible to obtain one which excels also at the aspect of safety, the aspect of hygiene, and the aspect of environment.

Further, in the heat cooking apparatus, the self-cleaning layer may be formed by having the self-cleaning powder material, which is formed by having the self-cleaning material dissolved in the porcelain enamel glaze and powdered, accreted to the porcelain enamel glaze which is applied to the stainless steel in advance and by bake-sticking.

Further, in the heat cooking apparatus, the self-cleaning layer maybe formed by having the self-cleaning powder material, which is formed by having the self-cleaning material dissolved in the porcelain enamel glaze and powdered, mixed with water and by applying to the stainless steel plate, and by having the self-cleaning powder material accreted to this powdered self-cleaning powder material and by bake-sticking.

As above, according to the heat cooking apparatus which is described above, by accreting and baking the self-cleaning power material which is powdered by having the self-cleaning material dissolved in the porcelain enamel glaze, it is possible to realize a porous self-cleaning layer, and by this, it is possible to increase a surface area of the self-cleaning layer to more improve the self-cleaning effect.

Further, in the heat cooking apparatus, the heater is disposed on a back side of a rear face plate which forms the heating chamber, and the self-cleaning layer is formed on the rear face plate.

As above, since the self-cleaning layer is formed on the rear face plate which is heated up to high temperature by the heater, it is possible to obtain the excellent self-cleaning effect on the rear face plate.

Further, in the heat cooking apparatus, the heater is disposed on an upper side of a top face plate which forms the heating chamber, and the self-cleaning layer is formed on the top face plate.

That is, since the self-cleaning layer is formed on the top face plate which is heated up to high temperature by the heater, it is possible to obtain the excellent self-cleaning effect on the top face plate.

Preferably, in the heat cooking apparatus, a plurality of air intake use through-holes and a plurality of air blowing use through-holes may be formed in the rear face plate, and on a back side of the rear face plate, disposed is a circulation fan which sucks air in the heating chamber from the air intake use through-hole after the air is heated by the heater, and at an inner side of the heating chamber of the rear face plate, placed is a collection plate having a plurality of through-holes, and the rear face plate is covered by the collection plate.

In short, since oil, seasoning and so on which are spattered from an object to be hated can be collected by the collection plate, it is possible to considerably reduce accretion of dirt to the rear face plate which is equipped with the circulation fan at a rear side for circulating and heating air in the heating chamber, and it is possible to have the self-cleaning performed surely on the rear face plate.

Preferably, in the heat cooking apparatus, the collection plate may be detachably placed in the heating chamber.

By this, it is possible to remove and wash the collection plate to which dirt is accreted, and it is extremely sanitary.

Preferably, in the heat cooking apparatus, the collection plate may be comprised of a steel plate, and on at least a surface of an inner side of the heating chamber, a fluorine resin coat layer is formed.

As above, by forming the fluorine resin coat layer which prevent dirt from being accreted to the collection plate, it is possible to wipe out the accreted dirt inside and outside of the heat cooking apparatus by cleaning, and it is possible to maintain a good sanitary condition. Also, by this, it is possible to considerably improve maintenance capability.

Preferably, in the heat cooking apparatus, the collection plate may be comprised of a porcelain enameling use steel plate, and after applying the porcelain enamel glaze as a ground coat, the self-cleaning material is applied and baked, and thereby, the self-cleaning layer is formed.

As above, it is possible to obtain the self-cleaning effect on both of the collection plate and the rear face plate, an it is possible to maintain a more favorable sanitary condition.

According to second aspect of the invention, a self-cleaning functional material is formed in such a manner that, on a surface of a substrate which is a stainless steel plate, a self-cleaning material, which is comprised of oxidation catalyst which oxide-decomposes accreted dirt at high temperature, is coated by use of a porcelain enamel glaze as an accretion material.

Preferably, in the self-cleaning functional material, the porcelain enamel glaze may be one which is formed by adding one type or more powder out of powder for enameling of aluminum, iron, nickel, copper, chromium, silver, bronze, and titanium to frit.

Preferably, the self-cleaning material may be comprised of oxidation catalyst of one type or more out of iron oxide, manganese oxide, and copper oxide.

As above, according to the self-cleaning functional material which is described above, since the self-cleaning layer was formed by accreting the self-cleaning material, which is not directly accreted to a stainless steel, to a stainless steel by use of the porcelain enamel glaze as the accretion material, as compared to such a case of accreting the self-cleaning material to the porcelain enameling use steel plate by complicated processes, it is possible to realize remarkable improvement of productivity and low cost, and over maintaining the sufficient self-cleaning effect, it is possible to have it had an excellent property also at an aspect of safety, an aspect of hygiene, and an aspect of environment.

Preferably, in the self-cleaning functional material, on a surface of the substrate, a ground coat layer of the porcelain enamel glaze, and a self-cleaning layer containing the self-cleaning material are formed in this order.

According to this structure, it is possible to accrete the self-cleaning material in powder form without change, and it is possible to facilitate to make holes of the self-cleaning layer. By this, it is possible to have the self-cleaning effect improved more, by increasing a surface area of the self-cleaning layer.

In a manufacturing method of a self-cleaning functional material, the self-cleaning layer is formed by having a self-cleaning powder material, which is dissolved in the porcelain enamel glaze and powdered, mixed with water and by applying to the substrate and by bake-sticking.

In short, since the self-cleaning layer is formed by mixing with water and applying and bake-sticking, as compared to heat-resisting painting or ceramics coating and so on using organic solvent, it is possible to obtain one which excels also at an aspect of safety, an aspect of hygiene, and an aspect of environment.

Preferably in the manufacturing method of a self-cleaning functional material, the self-cleaning layer may be formed by accreting a self-cleaning powder material, which is dissolved in the porcelain enamel glaze and powdered, to the porcelain enamel glaze which was applied to the substrate in advance and by bake-sticking.

Preferably, in the manufacturing method of a self-cleaning functional material, the self-cleaning layer may be formed by having a self-cleaning powder material, which is dissolved in the porcelain enamel glaze and powdered, mixed with water and by applying to the substrate and by accreting the self-cleaning powder material in powder form to this applied self-cleaning powder material and by bake-sticking.

As above, according to the manufacturing method of the self-cleaning functional material which is described above, by accreting the self-cleaning powder material, which was dissolved in the porcelain enamel glaze and powdered, and by bake-sticking, the self-cleaning layer can be transformed to one having many holes, and by this, it is possible to have the self-cleaning effect improved more, by increasing a surface area of the self-cleaning layer.

### BRIEF DESCRIPTION OF DRAWINGS

FIG. 1 is a front view showing a schematic structure of a heat cooking apparatus of the invention;

FIG. 2 is a schematic cross sectional view of the heat cooking apparatus of the invention;

FIG. 3 is a cross sectional view explaining a layer structure of a rear face plate;

FIG. 4 is a plan view showing an operation panel part which was disposed on an open and shut door of the heat cooking apparatus;

FIG. 5 is a cross sectional view of a heat cooking apparatus showing an example in which a plate member on which a SC layer was formed was disposed at a position other than the rear face plate;

FIG. 6 is a view viewed from above showing the heat cooking apparatus of FIG. 5 by use of a partial cross sectional view;

FIG. 7 is a cross sectional view showing a schematic structure of a heat cooking apparatus having a collection plate;

FIG. 8 is is an enlarged cross sectional view showing a layer structure of the collection plate;

FIG. 9 is a cross sectional view showing another example of forming the SC layer;

FIG. 10 is a cross sectional view showing still another example of forming the SC layer;

FIG. 11 are cross sectional views of test strips A to E which were used for a comparative test of a self-cleaning effect;

FIG. 12 is an explanatory view showing such an appearance that cooking oil is dropped on a coated surface of each test strip;

FIG. 13 is a microphotograph indicating a cross section of the test strip A;

FIG. 14 is a microphotograph indicating a cross section of the test strip C; and

FIG. 15 is a cross sectional view explaining a structure of a conventional heat cooking apparatus.

### DETAILED DESCRIPTION OF THE PREFERRED EMBODIMENTS

Hereinafter, a preferred embodiment of a heat cooking apparatus relating to this invention will be described in detail with reference to drawings.

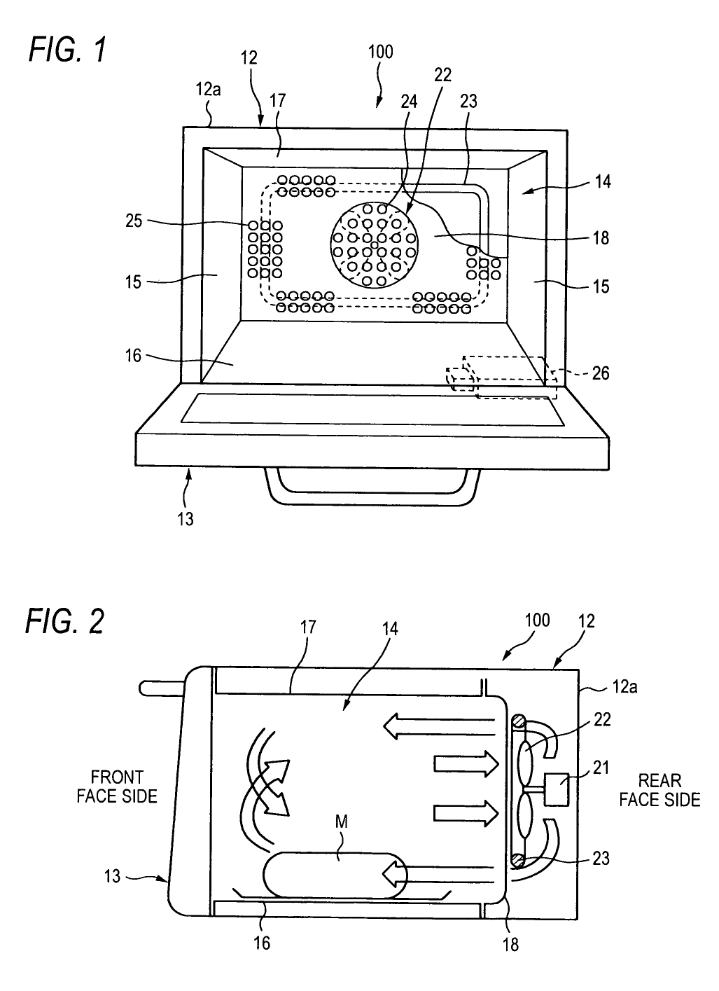

FIG. 1 is a front view showing a schematic structure of a heat cooking apparatus, and FIG. 2 is a schematic cross sectional view of the heat cooking apparatus.

As shown in FIGS. 1 and 2, a heat cooking apparatus 100 of the embodiment has a cooking apparatus main body 12, and an open and shut door which is disposed at a front face side of this cooking apparatus main body 12. In a main body case 12a which configures the cooking apparatus main body 12, formed is a heating chamber in which an object M to be heated can be housed, and it is designed that a space in the heating chamber 14 is opened and closed by the open and shut door 13.

Top, bottom, left and right of the heating chamber 14 which was formed in the main body case 12a of the cooking apparatus main body 12 are enclosed by plate members which are composed of side face plates 15, a bottom face plate 16 and a top face plate 17, and a rear face side thereof is covered by a plate member which is composed of a rear face plate 18.

The rear face plate 18 has, at its center of a back side thereof, a circulation fan 22 which is rotated by a drive motor 21, and also, at an outer circumference side of the circulation fan 22 on the back side, a convection heater (heater) 23 which is formed in the form of rectangular and circular shape is disposed along a back surface of the rear face plate 18. Therefore, the rear face plate 18 is directly heated by the convection heater 23 and temperature thereof is elevated to high temperature.

On the rear face plate 18, at its position facing to the circulation fan 22, a plurality of air intake use through-holes 24 are formed, and also, at its position facing the convection heater 23, a plurality of air blowing use through-holes 25 are formed. In addition, these the plurality of air intake use through-holes 24 and air blowing use through-holes 25 are comprised of punched holes which are press-formed in the rear face plate 18.

Also, on the cooking apparatus main body 12, at its lower part and so on, a magnetron 26 is disposed as a high frequency wave generation part which generates high frequency waves.

And, in the above-described heat cooking apparatus 11, it is designed that the object M to be heated is high-frequency heated by high frequency waves (micro waves) which were generated by the magnetron 26. As a heating system by use of the magnetron 26, either a system using a turning table or a system using a stirrer fin for agitating electric waves may be used. Also, air in the heating chamber 14 is sucked into the back surface side through the air intake use through-holes 24 of the rear face plate 18, by the circulation fan 22 which is selectively ON/OFF controlled according to a heating content. After that, it is heated up to high temperature by the convection heater 23, and fed in the heating chamber 14 again from the air blowing use through-holes 25. By this, for example, to grill heat cooking to the object M to be heated in the heating chamber 14 until the surface gets burned and so on is carried out. As above, in this heat cooking apparatus 100, it has a high frequency heating function by the magnetron 26 and an oven function by the convection heater 23.

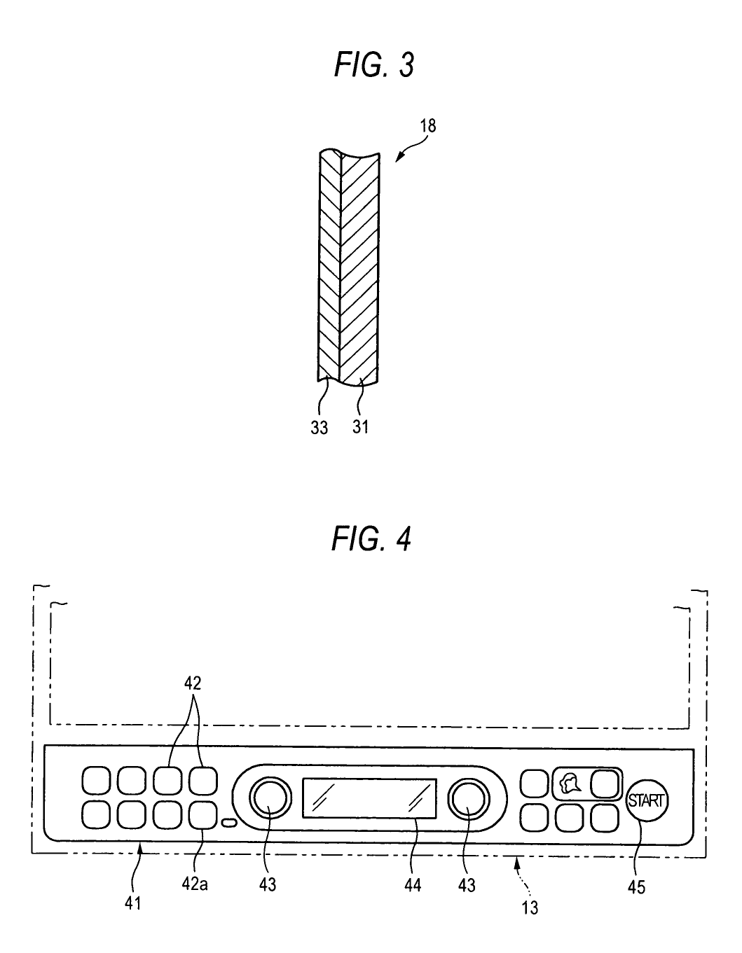

The rear face plate 18 which forms the heating chamber 14 of the heat cooking apparatus 100 with the above-described structure has, as shown in FIG. 3 in an enlarged manner, a self-cleaning layer (SC layer) 33 which contains a self-cleaning material (SC material) having a self-cleaning function, on a surface of an inner side of the heating chamber 14 of the stainless steel plate 31. This SC layer 33 is formed by having the SC material having the SC function mixed with a porcelain enamel glaze which enables enameling on a stainless steel which is described in a JP-A-9-42687 gazette and by laying this down to the stainless steel plate 31.

Here, as the SC material, one type or more of oxidation catalysts which are comprised of iron oxide, manganese oxide, copper oxide and so on.

Also, as the porcelain enamel glaze, after forming slip containing frit, clay, an electrolytic substance, and water, by adding one type or more powder out of powder for enamel of aluminum, iron, nickel, copper, chromium, silver, bronze, and titanium to this slip to form a mixture, this mixture is agitated and blended by use of a ball mill, a pub mill and so on to be conditioned. In addition, in the slip, pigment, stopping agent, additive, and so on may be contained.

As the frit, commodity substances which have been generally used through many years as a frit for enameling can be used, and as a representative one thereof, it is one which properly contains, SiO₂, A1₂O₃, B₂O₃, TiO₂, CaO, BaO, SrO, K₂O, Na₂O, Li₂O, F₂, NiO, CoO, MnO and so on.

As the electrolytic substance, cited are hydrated borax, soda nitrite, soda aluminate, magnesium carbonate and so on. Also, as to clay, stopping agent, pigment, additive and so on, normal amount of a commodity substance which is generally used as a material for enameling is used.

The porcelain enamel glaze which is used in this embodiment is, concretely speaking, one in which a powder for enameling of 60±5% by weight is added to frit of 100% by weight.

Also, as the stainless steel plate 31, ferritic stainless (SUS430 etc.), austenitic stainless (SUS304 etc.) can be used, and ferritic stainless is preferably used at low cost.

Here, processes in case of forming the SC layer 33 on the stainless steel plate 331 will be described in a content sequence of each process

(1) Defatting Process

Firstly, the stainless steel plate 31 is immersed into alkaline aqueous solution (about pH12) to carry out defatting of a surface thereof.

(2) Water Washing Process

The stainless steel plate 31 is picked out from the alkaline aqueous solution, and washed by use of water to wash away the alkaline aqueous solution. After that, the water washing is further repeated several times.

(3) Drying Process

The water-washed stainless steel plate 31 is dried at about 200° C. for about 10 minutes.

(4) Masking Process

A joint part by welding or caulking of the stainless steel plate 31 is masked, for example, by a magnet plate which is easy to be handled, and so on.

(5) SC Material Application Process

Firstly, the SC material is dissolved in the porcelain enamel glaze to make frit, and this fritted one is ground to be powdered. And, this powdered SC powder material is mixed with water and then, uniformly applied to the surface of the inner side of the heating chamber 14 of the stainless steel plate 31 by use of a spray gun and so on.

(6) Drying Process

After that, the stainless steel plate 31 is dried at about 100° C. for about 10 minutes.

(7) Masking Removal Process

After completion of drying, the masking such as the magnet plate and so on is removed from the stainless steel plate 31.

(8) Bake-Sticking Process

The stainless steel plate 31 is heated at about 810° C. for about 6 minutes, and the SC material is bake-stuck to a surface of the stainless steel plate 31.

By carrying out the above-described processes of (1) to (8), the SC material is bake-stuck to the surface of the inner side of the heating chamber 14 of the stainless steel plate 31 so that the SC layer 33 is formed.

And, in case of carrying out heat cooking by use of the heat cooking apparatus 11 in which the SC layer 33 was formed on the rear face plate 18 as above, under such a situation that the object M to be heated was put into the heating chamber and the open and shut door 13 was closed, a cooking key and a start button which will be described later are depressed.

By doing like this, high frequency heating by the magnetron 26, the oven heating by the convection heater 23 are selectively started, and the object M to be heated in the heating chamber 14 is heat-cooked, and in case that the circulation fan 22 was turned ON, by circulation wind which is fed in the heating chamber 14 by the circulation fan 22, the object M to be heated is heated uniformly.

At the time of this heat cooking, liquid etc. such as oil, seasoning and so on is spattered from the object M to be heated, and accreted to inner walls of the heating chamber 14, and in particular, on the rear face plate 18 where the convection heater 23 was disposed closely, materials which were accreted are heated at high temperature and intended to be changed to varnish. However, on this rear face plate 18, formed is the SC layer 33 which is comprised of the SC material having the self-cleaning function on the surface of the inner side of the heating chamber 14, and therefore, the accreted materials are surely oxide-decomposed at high temperature and evaporated to thereby be removed.

In addition, in the heat cooking apparatus 100, as shown in FIG. 4, an operation panel part 41 is disposed at a lower side on a front surface of the open and shut door 13. On this operation panel part 41, a plurality of setting switches 42 which are depressed on the occasion of carrying out various settings, an adjustment knob 43 for adjusting setting temperature, setting time and so on, a display part 44 where information such as setting contents and so on is displayed, and a start button 45 for activating the heat cooking apparatus 11, and so on are disposed.

And, various setting are carried out by the setting switches 42 and the adjustment knob 43, and after confirmed on the display part 44, by depressing the start button 45, cooking of the object M to be heated which was placed in the heating chamber 14 is to be carried out on the basis of temperature, time and so on which were set.

Here, one of the setting switches 42 is to be a care switch 42a. This care switch 42a is one which was disposed for carrying out cleaning of the rear face plate 18 as needed, other than the self-cleaning of the rear face plate 18 by oven heating at the time of cooking, and by depressing this care switch 42a, it is to be switched to a care mode.

In this care mode, upon depressing the start button 45, the convection heater 23 is turned ON, and the rear face plate 18 is heated up to high temperature, and by this, accreted materials which were not decomposed sufficiently at the time of cooking and stayed behind on the rear face plate 18 are to be completely decomposed and removed due to such a fact that the rear faceplate 18 is heated and the self-cleaning is carried out.

As above, according to the heat cooking apparatus 100 of this embodiment, by accreting the SC material, which is not normally accreted to the stainless steel plate 31, to the rear face plate which forms the heating chamber 14 by use of the porcelain enamel glaze as the accretion material, the SC layer 33 is formed, and this stainless steel plate 31 on which the SC layer 33 was formed is used as the rear face plate 18. By this, it is possible to have the self-cleaning effect performed sufficiently by the rear face plate 18 which is heated up to high temperature by the convection heater 23, and it is possible to surely decompose and remove dirt which was accreted by the SC layer 33.

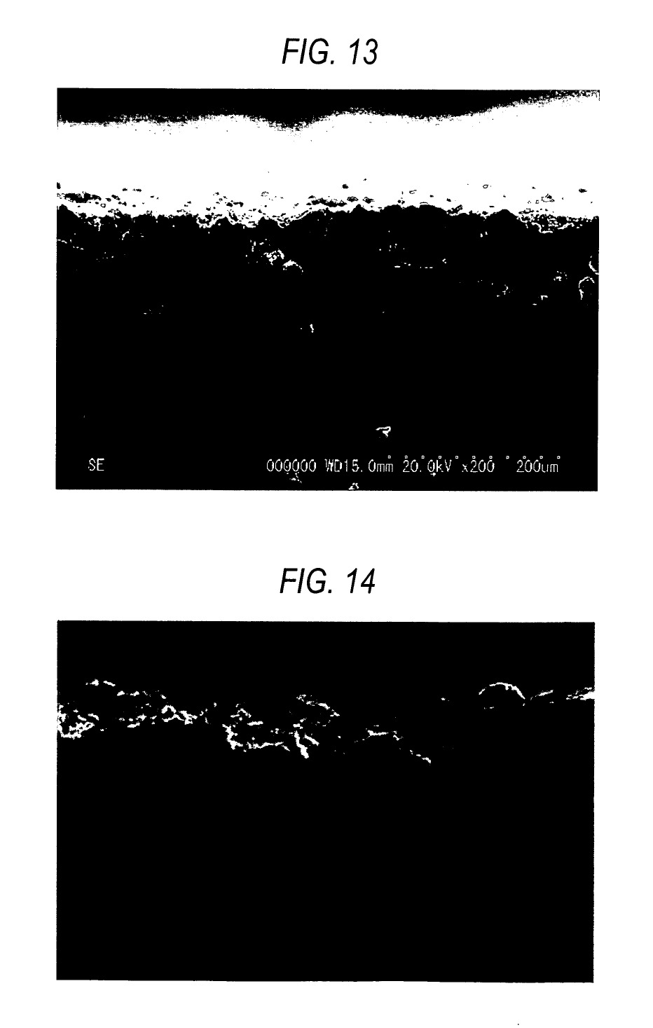

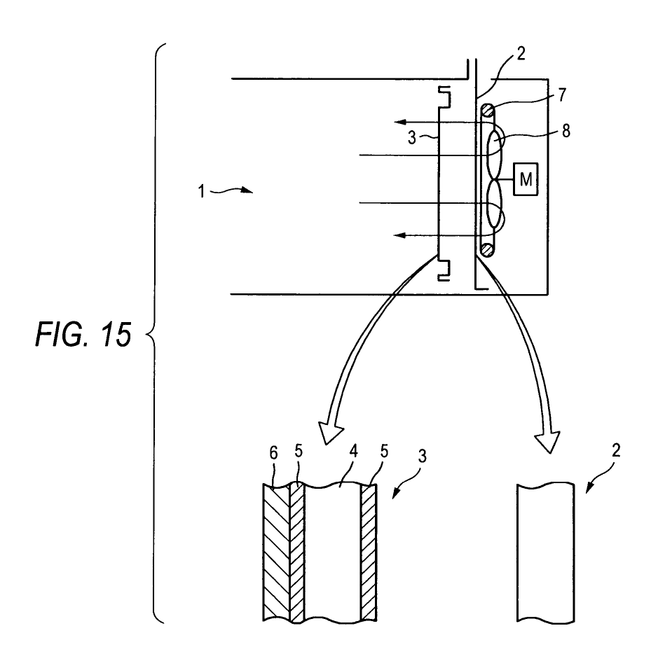

In short, as compared to a conventional front face plate 3 shown in FIG. 13 which has no other choice to be disposed away from a convection hear in some degree since there occur defects such as crazing, cracks and son on in a ground coat layer to which the SC material is accreted, it is possible to have an extremely excellent self-cleaning effect generated.

Also, it is possible to eliminate a thick porcelain enameling use steel plate 4 to which the SC material was accreted by complicated processes, and it is possible to realize weight saving and low cost, and it is possible to reduce necessary heater capacity, and it is possible to realize reduction of electric power consumption.

Also, since the SC layer 33 is formed by mixing with water and applying and bake-sticking, as compared to heat-resisting painting or ceramics coating using organic solvent and so on, it is possible to have it become one which excels also at an aspect of safety, an aspect of hygiene, and an aspect of environment.

Also, in the above-described example, it was arranged that the convection heater is disposed at a back side of the heating chamber 14, and the SC layer 33 is formed on the rear face plate 18 which is heated up to high temperature by this convection heater 33 to realize the self-cleaning, but a portion where the SC layer 33 is disposed is not limited to the rear face plate 18, if it is a portion which is heated up to enough temperature for the self-cleaning.

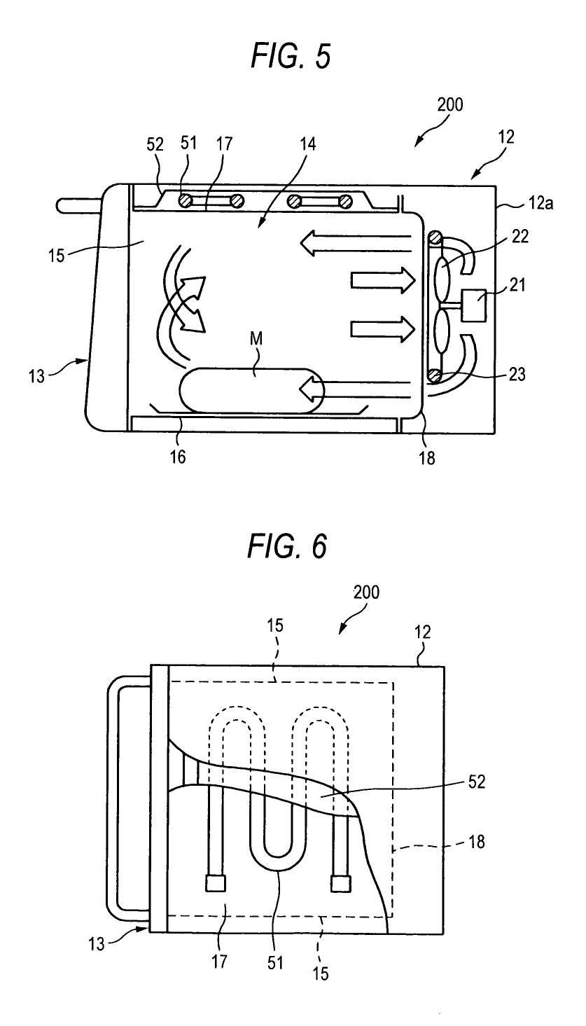

Here, FIG. 5 is a cross sectional view of a heat cooking apparatus showing such an example that a plate member on which the SC layer was formed was disposed at a position other than the rear face plate, and FIG. 6 is a view viewed from above showing the heat cooking apparatus of FIG. 5 by use of a partial cross sectional view.

A heat cooking apparatus 200 shown in FIG. 6 is of such a structure that in order to heat the object M to be heated in the heating chamber 14 from the top face side, on an upper part of the heating chamber 14, a convection heater 51 of a shape viewed from a planar surface as shown in FIG. 6 was disposed. In this case, on not only the rear face plate 18 but also the top face plate 17 on which the convection heater 51 is disposed along the surface, the SC layer 33 is formed at the inner side of the heating chamber 14.

In addition, above the convection heater 51, mounted is an insulation plate 52 for suppressing heat transfer of the convection heater to an upper surface of the heat cooking apparatus main body 12, and for reflecting heat ray to the heating chamber side.

And, in this heat cooking apparatus, the top face plate 17 as well as the rear face plate 18 is heated by the convection heater 51, and sufficient self-cleaning due to the both is carried out. Furthermore, if the heat cooking apparatus is one which can be heated up to high temperature, for example, 300° C. or more, by disposed on substantially entire surfaces which form the heating chamber 14, it is possible to additionally obtain the self-cleaning effect due to heat at the time of heating.

Next, a second embodiment of a heat cooking apparatus relating to the invention will be described.

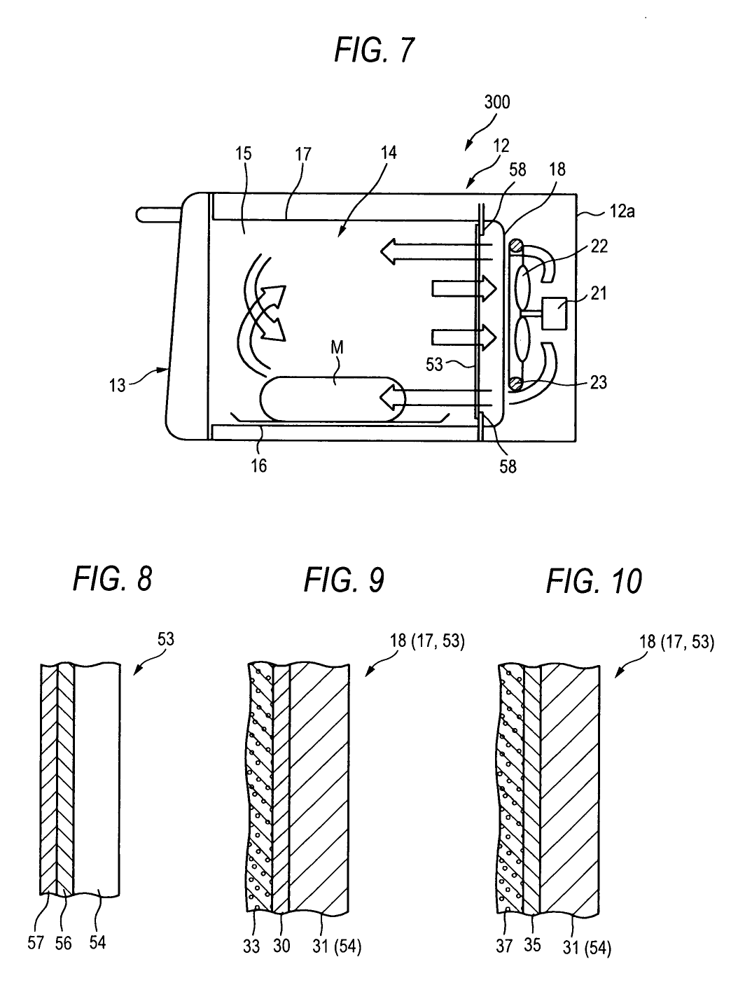

FIG. 7 is a cross sectional view showing a schematic structure of a heat cooking apparatus of this embodiment, and FIG. 8 shows an enlarged cross sectional view of a collection plate. This heat cooking apparatus 300 is of such a structure that, in the vicinity of a front side (an inner side of the heating chamber 14) of the rear faceplate 18, a collection plate 53 is disposed so as to cover this rear face plate 18.

This collection plate 52 is, as shown in FIG. 8, one in which, on the surface of the inner side of the heating chamber 14 of a stainless steel plate 54, a ground coat layer (PES: polyether sulfon resin) 56, a fluorine resin coat layer (PTFE: polytetrafluoroethylene, or PFA: tetrafluoroethylene) 57 are formed in this order, and across an entire surface, through-holes (graphic display omitted) which are comprised of punched holes are disposed.

And, it is designed that this collection plate 53 is attached to fixing pieces 58 which were disposed on the side face plate 15, the bottom face plate 16, the side face plate 15 and so on, respectively, by screw fixing or detachably by locking means such as a clip and so on, in the vicinity of the front side of the rear face plate 18, at its top and bottom end parts. IN addition, in case of a detachable structure, there is a necessity to make a locking structure which prevents generation of a spark due to concentration of electric fields at the time of high frequency heating.

According to the heat cooking apparatus 300 having the suchlike collection plate 53, since it is possible to capture oil, seasoning and so on which are spattered from the object M to be heated by firstly accreting them to the collection plate 53, it is possible to considerably reduce accretion of dirt to the rear face plate 18 which was disposed at the back side of the circulation fan 22 which circulates air in the heating chamber 14. Also, one which could not be captured by the collection plate 53 is accreted to the rear face plate 18, but it is possible to surely remove the accreted dirt by the self-cleaning on the rear face plate 18.

Also, since the fluorine resin coat is applied to a surface of the collection plate 53, it is possible to easily wipe out the accreted dirt by non-adherence of the coat surface, and it is possible to keep an extremely sanitary situation. Furthermore, in case that the collection plate 53 was attached in a detachable manner, it is possible to detach the collection plate 53 to which dirt was accreted as it is to outside of the heating chamber and wash it, and it is possible to remove the dirt of the collection plate 53 with good workability and more finely.

In addition, it is possible to configure the collection plate 53 as one with similar layer structure to the rear face plate, other than forming the above-described fluorine resin coat layer 55. That is, it may be designed that the ground coat layer is formed on both surfaces of the stainless steel plate and the SC layer is formed on the surface of the inner side of the heating chamber. IN this case, it is possible to obtain the self-cleaning effect by both of the collection plate 53 and the rear face plate 18, and it is possible to maintain a good sanitary situation.

As to the rear face plate 18, the top face plate 17 on which the SC layer was formed and the collection plate 53 in each embodiment which was described above, they are not limited to the above-described layer structure, and for example, may be of a layer structure which is shown as follows.

Here, another example of forming the SC layer will be described.

What is shown in FIG. 9 is of such a layer structure that the ground coat layer 30 and the SC layer 33 were stacked in this order on the surface of the stainless steel plate 31. In this case, the SC layer 33 is formed in such a manner that, to the surface of the inner side of the heating chamber 14 of the stainless steel plate 31 (51 in the same manner), the porcelain enamel glaze in liquid form, which is capable of enameling on the above-described stainless steel plate, is applied to make this as the ground coat layer 30, and furthermore, after dried, the SC powder material of powder type containing the SC material is accreted to an application surface of this porcelain enamel glaze, and after that, it is bake-stuck so that the SC layer 33 is formed.

What is shown in FIG. 10 is of such a layer structure that the SC layer 35 to which the SC material was applied in liquid form and the SC layer 37 to which the SC material was applied in powder form without change were stacked in this order on the surface of the stainless steel plate 31. In this case, the SC layer 33 is formed in such a manner that, to the surface of the inner side of the heating chamber 14 of the stainless steel plate 31 (51), the SC powder material is mixed with water and then, applied, and after that, it is bake-stuck so that the SC layer 33 is formed.

Like the above-described layer structure of FIG. 9 and FIG. 10, by accreting the SC powder material containing the SC material without being mixed with water and by forming the SC layers 33 and 37, it is possible to further facilitate to make holes of the SC layers 33 and 37. By transforming a structure of the SC layers 33 and 37 to that having many holes, a surface area of the SC layers 33 and 37 is increased, and by this, it is possible to further improve the self-cleaning effect by the SC layers 33 and 37.

### Comparative Evaluation of Various SC Layers

As to a plurality of test strips to which various coatings corresponding to the plate member having self-cleaning functional material of this invention were applied, test for checking the self-cleaning effect and compared. Hereinafter, its detail will be described. In addition, the porcelain enamel glaze here is a porcelain enamel glaze which is capable of enameling on the above-described stainless steel plate.

[1] Test Strip

(1) Test Strip A

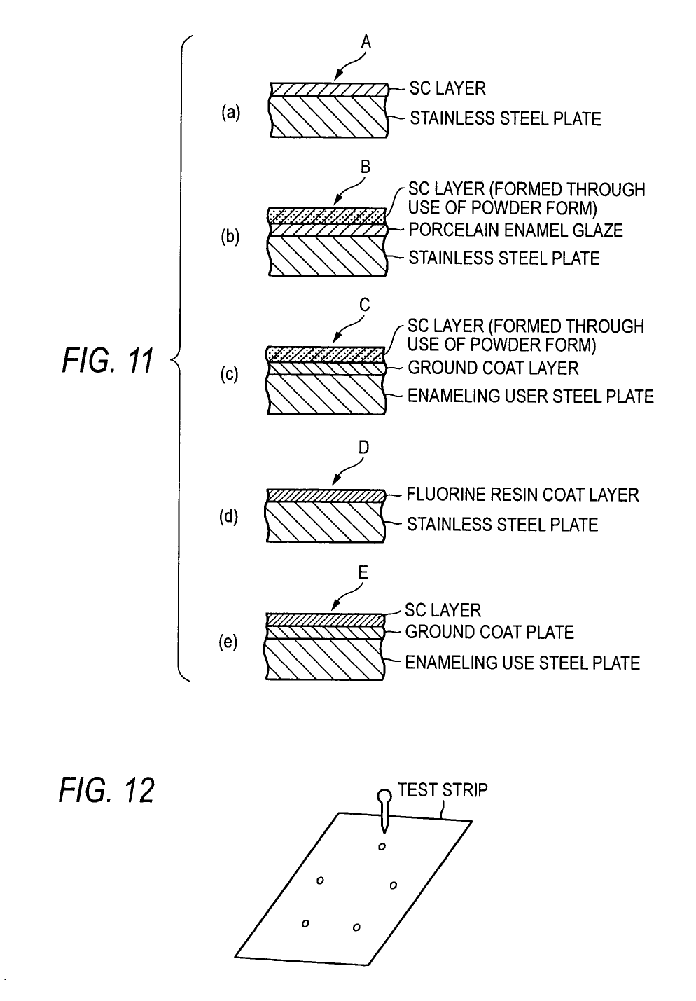

One which is formed in such a manner that the SC material and the porcelain enamel glaze are dissolved to form a frit, and then, ground to make the SC powder material, and the powdered SC powder material is mixed with water, and its mixed solution is applied to a surface of the stainless steel plate and then, bake-stuck to form a SC layer (about 100 μm film thickness) (see, FIG. 11(a)).

(2) Test Strip B

One which is formed in such a manner that the porcelain enamel glaze is applied to a surface of the stainless steel plate (about 50 μm film thickness), and after dried, furthermore, the SC powder material is accreted to an porcelain enamel glaze application surface and bake-stuck to form a porous SC layer (about 120 μm film thickness) (see, FIG. 11(b)).

(3) Test Strip C

One which is formed in such a manner that a ground coat layer (about 50 μm film thickness) such as aluminum oxide and so on is formed on a surface of a steel plate for enameling, and furthermore, the SC powder material is applied to the ground coat layer to form a porous SC layer (about 100 μm film thickness) (see, FIG. 11(c)).

(4) Test Strip D

On which is formed by coating a surface of a stainless steel plate with fluorine resin (12 μm film thickness) (see, FIG. 11(d)).

(5) Test Strip E

One which is a conventional SC layer and formed in such a manner that a ground coat layer (50-60 μm film thickness) such as aluminum oxide and so on is applied to a steel plate for enameling and bake-stuck, and furthermore, the SC material is accreted by wet type painting which is generally used, and after that, it is bake-stuck to form a SC layer (100 μm film thickness) (see, FIG. 11(e)).

[2] Test Method

On the basis of a standard test method which is defined in ISO 8291, the test is carried out in the following procedures.

(I) On a coated surface of each test strip, as shown in FIG. 12, cooking oil is dropped by use of a dropper and so on at 5 places in total, and the cooking oil is permeated into the coated surface.

(II) The test strip to which the cooking oil was dropped is put into a heating furnace and heated up to 250° C., and held for 1 hour.

(III) The test strip is picked out from the heating furnace, and presence and absence of change to varnish of the cooking oil which was dropped on the test strip are confirmed visually.

(IV) Processes of the above-described (I) to (III) are repeated until the change to varnish occurs at any one of the 5 planes, and the number of the repetition is recorded.

Furthermore, in order to check thermal dependency of the self-cleaning effect, a similar test was carried out for temperature of 300° C., 350° C., in addition to the above-described heating temperature of 250° C.

[3] Test Result

Test results at each heating temperature 250° C., 300° C., 350° C. for each test strip A to E are shown in a table 1.

TABLE 1
Number of Repetition by which Self-Cleaning Effect was recognized

| Test | Test | Test | Test | Test | Test |
|---|---|---|---|---|---|
| Temperature | Strip A | Strip B | Strip C | Strip D | Strip E |
| 250° C. | 7 | 10 | 8 | (40) | 4-5 |
| 300° C. | 8 | (25) | 19 | 19 | 5-6 |
| 350° C. | 12 | (35) | 25 | 6 | 7-8 |

( ) means the minimum number of repetition

The test strips A, B, C corresponding to this invention have the raised number of repetition to the test strip E which is a conventional one, and it is recognized that they perform an excellent self-cleaning effect as temperature becomes high, and in particular, it was recognized that the test strip B, which was formed by transforming a structure of the SC layer to that with many holes, has an extremely excellent self-cleaning effect.

Also, in the test strip C which corresponds to the front face plate 3 which was described in the prior art, it was recognized that the self-cleaning effect is improved as temperature becomes high.

On one hand, since there is no self-cleaning effect to the test strip D which does not contain the SC layer and to which the fluorine resin coat was applied, it is indicated by the number of repetition until the cooking oil is strongly and closely contacted to a fluorine resin coated surface, after the dropped cooking oil is removed each time of repetition. In the test result of the test strip D, wettability to the cooking oil is low due to a coating effect of the fluorine resin at temperature of about 250° C., and the cooking oil-after heated could be easily removed, but when temperature becomes high up to high temperature of 300° C. and more exceeding continuous use heat-resistant temperature 260° C. of the fluorine resin coat, bake-sticking occurs and the number of repetition is extremely reduced.

As above, in the test strips A, B, C having the SC layer, obtained is the number of repetition which is practically sufficient even at temperature of about 250° C., and recognized was such a trend that the self-cleaning effect is improved as temperature becomes high for each of them.

Therefore, in case that coating of the SC material was carried out, it is possible to further increase the self-cleaning effect, by disposing it in the vicinity of the convection heater.

Also, in the test strip D to which the fluorine resin coat was applied, it was recognized that the self-cleaning effect was remarkably declined as temperature becomes high, but since the collection plate which is disposed at a position which is a little bit away from the convection heater is not exposed to high temperature, it is possible to apply this. Rather, since a dirt-resistant effect is high due to its non-adherence, in a temperature zone of less than 250° C., it can be preferably utilized as a collection plate.

As described above, by disposing a plate member on which the SC layer was formed in the vicinity of the convection heater, it becomes possible to sufficiently pull out the self-cleaning effect that the SC material inherently has. In addition, film thickness of the SC layer is preferably 100 μm to 150 μm, from the view point of the self-cleaning effect that a heat cooking apparatus requires and cost and adhesion. Also, in case of accreting and bake-sticking the SC material as powder type, a structure of the SC layer is easily transformed to that having many holes, and it is possible to have the self-cleaning effect further improved at each temperature by increase of a surface area.

Here, a microphotograph indicating a cross section of the test strip A was shown in FIG. 13 and a microphotograph indicating a cross section of the test strip C was shown in FIG. 14. The SC layer shown in FIG. 13 is one which was formed by being applied in liquid form, and the SC layer shown in FIG. 14 is one which was formed by the SC powder material being applied in powder form without change. Comparing these, the SC layer which was applied in powder form has a stronger porous aspect than in the SC layer which was applied in liquid form, and it can be seen that the self-cleaning effect due to the SC layer becomes larger as the surface are of the SC material increases.

According to a heat cooking apparatus of this invention, since a self-cleaning layer was formed by accreting a self-cleaning material which is not accreted to a stainless steel plate that is used as a plate member forming a heating chamber by use of a porcelain enamel glaze as an accretion material, particularly, in a plate member which is directly heated by a heater, it is heated up to high temperature so that it is possible to have a self-cleaning effect in a self-cleaning layer performed sufficiently, and it is possible to surely decompose and remove dirt which was accreted by the self-cleaning layer.

Also, it is possible to eliminate a thick front face plate which was formed by accreting the self-cleaning material to a porcelain enameling use steel plate by complicated processes, and it is possible to realize weight saving and low cost, and it is possible to reduce a necessary heater capacity, and it is possible to realize reduction of electric power consumption.

According to a self-cleaning functional material and its manufacturing method of the invention, since a self-cleaning layer was formed by accreting a self-cleaning material, which is not accreted directly to a stainless steel, to a stainless steel plate by use of a porcelain enamel glaze as an accretion material, it is possible to have the self-cleaning effect performed sufficiently without inviting increase of cost, and an excellent performance is demonstrated also at an aspect of safety, an aspect of hygiene, and an aspect of environment.

What is claimed is:

1. A heat cooking apparatus having a heating chamber enclosed by plate members in which an object to be heated that is housed in the heating chamber is heated and cooked by a heater which is disposed along a part of the plate member forming the heating chamber,
wherein out of the plate members which form the heating chamber, at least the plate member which is directly heated by the heater is comprised of a stainless steel plate, and on a surface of an inner side of the heating chamber of this stainless steel plate, a self-cleaning layer is formed by coating a self-cleaning material, which is comprised of an oxidation catalyst which decomposes accreted dirt, by use of a porcelain enamel glaze as an accretion material.

2. The heat cooking apparatus as set forth in claim 1, wherein the porcelain enamel glaze is one in which one type or more powder out of powders for enameling of aluminum, iron, nickel, copper, chromium, silver, bronze, and titanium is added to frit.

3. The heat cooking apparatus as set forth in claim 1, wherein the self-cleaning material is comprised of one type or more oxidation catalyst out of iron oxide, manganese oxide, and copper oxide.

4. The heat cooking apparatus as set forth in claim 1, wherein the self-cleaning layer is formed by having the self-cleaning powder material, which is formed by having the self-cleaning material dissolved in the porcelain enamel glaze and powdered, mixed with water and by applying to the stainless steel plate and by bake-sticking.

5. The heat cooking apparatus as set forth in claim 1, wherein the self-cleaning layer is formed by having the self-cleaning powder material, which is formed by having the self-cleaning material dissolved in the porcelain enamel glaze and powdered, accreted to the porcelain enamel glaze which is applied to the stainless steel in advance and by bake-sticking.

6. The heat cooking apparatus as set forth in claim 1, wherein the self-cleaning layer is formed by having the self-cleaning powder material, which is formed by having the self-cleaning material dissolved in the porcelain enamel glaze and powdered, mixed with water and by applying to the stainless steel plate, and by having the self-cleaning powder material accreted to this powdered self-cleaning powder material and by bake-sticking.

7. The heat cooking apparatus as set forth in claim 1, wherein the heater is disposed on a back side of a rear face plate which forms the heating chamber, and the self-cleaning layer is formed on the rear face plate.

8. The heat cooking apparatus as set forth in claim 1, wherein the heater is disposed on an upper side of a top face plate which forms the heating chamber, and the self-cleaning layer is formed on the top face plate.

9. The heat cooking apparatus as set forth in claim 1, wherein a plurality of air intake use through-holes and a plurality of air blowing use through-holes are formed in the rear face plate, and on a back side of the rear face plate, disposed is a circulation fan which sucks air in the heating chamber from the air intake use through-hole after the air is heated by the heater, and at an inner side of the heating chamber of the rear face plate, placed is a collection plate having a plurality of through-holes, and the rear face plate is covered by the collection plate.

10. The heat cooking apparatus as set forth in claim 9, wherein the collection plate is detachably placed in the heating chamber.

11. The heat cooking apparatus as set forth in claim 9, wherein the collection plate is comprised of a corrosion resistance steel plate, and on at least a surface of an inner side of the heating chamber, a fluorine resin coat layer is formed.

12. The heat cooling apparatus as set forth in claim 9, wherein the collection plate is comprised of a porcelain enameling use steel plate, and after applying the porcelain enamel glaze as a ground coat, the self-cleaning material is applied and baked, and thereby, the self-cleaning layer is formed.

13. A self-cleaning functional material characterized in that a self-cleaning layer is formed in such a manner that, on a surface of a substrate which is a stainless steel plate, a self-cleaning material, which is comprised of oxidation catalyst which oxide-decomposes accreted dirt at high temperature, is coated by use of a porcelain enamel glaze as an accretion material.

14. The self-cleaning functional material as set forth in claim 13, wherein the porcelain enamel glaze is one which is formed by adding one type or more powder out of powder for enameling of aluminum, iron, nickel, copper, chromium, silver, bronze, and titanium to frit.

15. The self-cleaning functional material as set forth in claim 13, wherein the self-cleaning material is comprised of an oxidation catalyst of one type or more out of iron oxide, manganese oxide, and copper oxide.

16. The self-cleaning functional material as set forth in claim 13, wherein on a surface of the substrate, a ground coat layer of the porcelain enamel glaze, and a self-cleaning layer containing the self-cleaning material are formed in this order.

17. A manufacturing method of the self-cleaning functional material as set forth in claim 13, and
a manufacturing method of the self-cleaning method characterized in that the self-cleaning layer is formed by having a self-cleaning powder material, which is dissolved in the porcelain enamel glaze and powdered, mixed with water and by applying to the substrate and by bake-sticking.

18. A manufacturing method of the self-cleaning functional material as set forth in claim 13, and
a manufacturing method of the self-cleaning method characterized in that the self-cleaning layer is formed by accreting a self-cleaning powder material, which is dissolved in the porcelain enamel glaze and powdered, to the porcelain enamel glaze which was applied to the substrate in advance and by bake-sticking.

19. A manufacturing method of the self-cleaning functional material as set forth in claim 13, and
a manufacturing method of the self-cleaning method characterized in that the self-cleaning layer is formed by having a self-cleaning powder material, which is dissolved in the porcelain enamel glaze and powdered, mixed with water and by applying to the substrate and by accreting the self-cleaning powder material in powder form to this applied self-cleaning powder material and by bake-sticking.
